(19) United States
(12) Patent Application Publication
(10) Pub. No.: US 2002/0155817 A1
(43) Pub. Date: Oct. 24, 2002

(54) Regulation for saturated systems

(76) Inventors: Per-Olof Brandt, Staffanstorp (SE); Tagi Farzone, Lund (SE)

Correspondence Address: JENKENS & GILCHRIST, PC, 1445 ROSS AVENUE, SUITE 3200, DALLAS, TX, 75202, US

(21) Appl. No.: 09/839,462

(22) Filed: Apr. 20, 2001

(51) Int. Cl. H04B 17/00

(52) U.S. Cl. 455/67.1; 455/127; 455/115; 455/226.1

(57) ABSTRACT

A power amplifier system and a method for controlling a power amplifier in a power amplifier system. The method controls the power amplifier in a power amplifier system which has a loop by which a parameter proportional to the output power of the power amplifier is sensed and fed back to an error amplifier, and the output of the error amplifier is fed to a control input of the power amplifier as a control signal. The method adds an extra gain to the loop. By adding the extra gain, the loop will always be in an active condition, even at very low output power levels and at high power levels so as to provide for a more robust power regulation.

### BACKGROUND OF THE INVENTION

1. Field of the Invention

The present invention relates generally to the field of power amplifiers; and more particularly, to a method and apparatus for controlling a power amplifier in a cellular telephone utilized in a wireless digital communications system.

2. Description of the Prior Art

Cellular telephones used in wireless digital communications systems; for example, communications systems which operate in accordance with GSM (Global System for Mobile Communications) specifications, contain a power amplifier system to control output power when the telephone is in the transmit mode. The output power is typically controlled by regulating the current, which is proportional to the output power, although other parameters proportional to the output power can also be regulated, if desired.

In the prior art, it is known to control a power amplifier by sensing the current to the power amplifier and feeding it back to an error amplifier. The output of the error amplifier is fed to a control input of the power amplifier; which, in turn, controls the biasing of the power amplifier. A filter is also usually included in the loop to set the bandwidth of the loop so as to not get too much noise into the system.

In a power amplifier system such as described above, the power amplifier transfer function gain, is not constant. In a GSM power amplifier system, for example, the gain can change by as much as a factor of 5 during normal operation. This change in the gain causes the bandwidth of the loop to also change by the same amount.

The problem becomes particularly serious at very low output power levels and at high output power levels. This is illustrated in FIG. 1 which is a graph schematically illustrating power amplifier transfer function gain; i.e., the control signal (Vcon) to current consumption (or output power), for the prior art system. The curve 10 in FIG. 1 clearly shows that at very low output power levels 12 and at high power levels 14, the output power essentially does not change with increase in Vcon.

At very low output power levels and at high output power levels, any change in the gain that does occur will result in a relative gain change that approaches infinity because there was essentially no gain at all to start with. Because there is no response in the loop feedback, the loop is not working and is not active.

The cause of the above-described problem is that the control signal into the power amplifier rises or falls with a rise and fall time that is completely determined by how the error amplifier is designed. Because the loop is not locked, the delay caused by the very low gain will change too much if either the supply voltage or the temperature changes.

Providing a solution to the delay problem is both difficult and time-consuming; and is generally required in each new telephone system development project. Usually, the solution necessitates that some compromises be made with respect to other parameters in the system.

### SUMMARY OF THE INVENTION

The present invention provides a power amplifier system and a method for controlling a power amplifier in a power amplifier system. A method according to the present invention controls a power amplifier in a power amplifier system which includes a loop by which a parameter proportional to output power of the power amplifier is sensed and fed back to an error amplifier, and the output of the error amplifier is fed to a control input of the power amplifier as a control signal, the method comprising adding an extra gain to the loop.

By adding extra gain to the loop, the loop will always be active; and because the loop will always be locked, there will no longer be any problems with delay as in prior art systems. The present invention thus provides an effective, yet relatively simple way, to obtain more robust power regulation.

According to a preferred embodiment of the invention, the extra gain is proportional to the control signal; and, in an implementation of the invention, the parameter proportional to the output power comprises current. A control circuit of the system adjusts the gain of the power amplifier and adds an appropriate extra gain to ensure that the loop will always be active.

According to a further embodiment of the invention, the power amplifier system is incorporated in a mobile terminal, for example, a cellular telephone, utilized in a wireless digital communications system, such as in a system operating in accordance with GSM specifications.

The method and system of the present invention also provides solutions to other problems that are encountered in power amplifier systems, including problems relating to mismatch at the output of the power amplifier.

Yet further advantages and specific features of the invention will become apparent hereinafter in conjunction with the following detailed description of presently preferred embodiments.

### BRIEF DESCRIPTION OF THE DRAWINGS

FIG. 1 is a graph schematically illustrating power amplifier transfer function gain in a power amplifier system that is known in the prior art;

FIGS. 2 and 3 are graphs schematically illustrating a method for adding extra gain in a power amplifier system according to a presently preferred embodiment of the present invention; and

FIG. 4 illustrates a power amplifier system according to one embodiment of the present invention.

### DETAILED DESCRIPTION OF PRESENTLY PREFERRED EMBODIMENTS OF THE INVENTION

As described above, in a conventional power amplifier system, a power amplifier is controlled by sensing the current to the power amplifier and feeding it back via a loop to an error amplifier, the output of which is fed to a control input of the power amplifier; which, in turn, controls the biasing of the power amplifier. As also described above; in such systems, the power amplifier transfer function gain is not constant; and this causes the loop to also change. At very low and at high power levels, in particular, there is essentially no gain at all, and any change in the gain that does occur results in an almost infinite relative change in the gain. Because there is no response in the loop feedback, the loop is not working and is inactive.

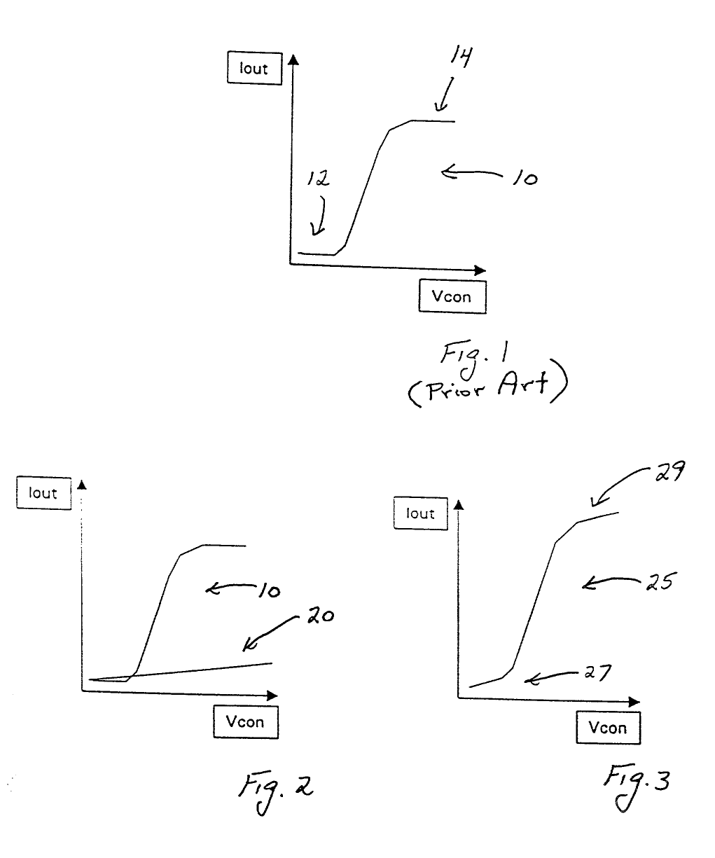

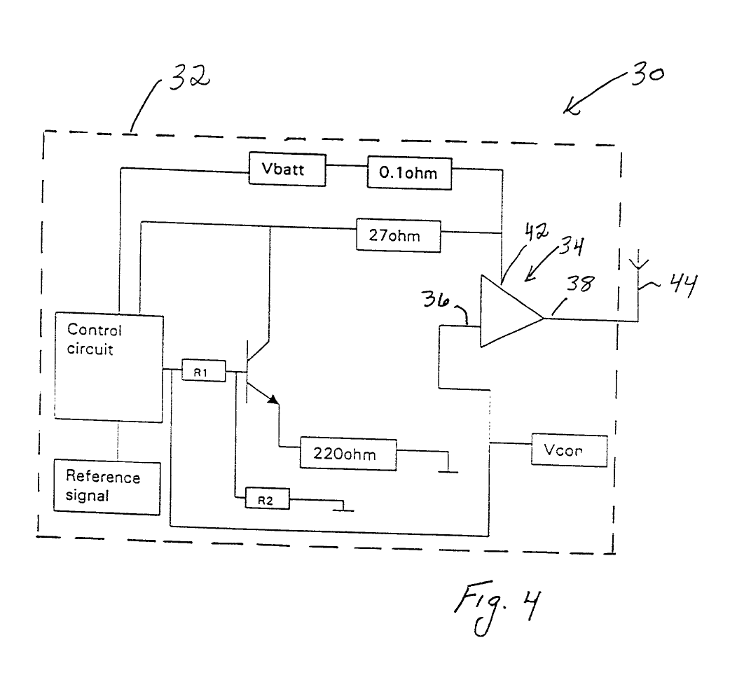

The present invention alleviates the above problems by adding an extra gain to the loop. This is shown in FIGS. 2 and 3 which are graphs of power amplifier transfer function gain illustrating a method according to the present invention. In particular, FIG. 2 illustrates the gain curve 10 shown in FIG. 1; and an extra gain curve 20 to be added to the curve 10 according to a presently preferred embodiment of the present invention. FIG. 3 illustrates the resulting curve 25 after adding the extra gain curve 20 to the curve 10.

As is clearly shown by the curve 25 in FIG. 3, by adding the extra gain, the overall gain will never be at zero, and there will always be some gain, even at very low output power levels as shown at 27 and at high output power levels as shown at 29. As a result, the loop will always be active; and because the loop is always locked, there will no longer be any problems with delay.

FIG. 4 illustrates a power amplifier system according to an embodiment of the present invention for providing the extra gain. The system is generally designated by reference number 30, and in this embodiment, the system is incorporated in a cellular telephone, illustrated by dashed box 32, utilized, for example, in a GSM wireless communications system; to control output power when the telephone is in the transmit mode.

System 30 includes a power amplifier 34 which receives a first RF signal, having a first power level, at an input 36; and which outputs a second RF signal, having a second power level, at output 38. The difference between the first and second power levels, i.e., the gain of the power amplifier, is controlled by a control signal which is input to the power amplifier at control signal input 42. As shown in FIG. 4, the second, amplified RF signal is transmitted by the telephone via an antenna 44.

The control signal at control signal input 42 is provided by sensing the input current to the power amplifier and feeding it to an error amplifier. The output signal from the error amplifier is fed to the control signal input 42 of the power amplifier 34.

The control circuit as so far described is known in the prior art; and will provide a power amplifier transfer function gain in the general form illustrated in FIG. 1. In accordance with the present invention, however, the power amplifier system 30 further includes additional circuitry for adding extra gain to the loop which is proportional to the control signal. As a result of this extra gain, the feedback loop will always be active, as shown in FIG. 3, and there will be no further problem with the delay because the loop will always be locked.

It should be recognized that FIG. 4 illustrates only one possible implementation for adding the extra gain to the loop. Other implementations will be readily apparent to those skilled in the art.

The present invention also provides a solution to mismatch at the output of the power amplifier. Specifically, if a big enough VSWR (Voltage Standing Wave Ratio) at the antenna has a certain phase; the power amplifier will be presented with an increased load impedance. This results in the power amplifier going into saturation earlier. When the down ramping should occur, we would get a delay without adding the extra gain according to the present invention.

In addition, because of the delay problem, the spectrum content in the switching spectrum gets very bad. This is because when the delayed response again becomes active, the reference level has already been decreased because of the delay. This results in that the slope of the ramping gets very sharp; and, therefore, introduces a wide spectrum. The present invention avoids these kinds of problems.

It should be emphasized that the term “comprises/comprising” when used in this specification is taken to specify the presence of stated features, integers, steps or components but does not preclude the presence or addition of one or more other features, integers, steps, components or groups thereof

It should also be recognized that the invention can be varied in numerous ways without departing from the scope thereof. Accordingly, it should be understood that the invention should be limited only insofar as is required by the scope of the following claims.

1. A method for controlling a power amplifier in a power amplifier system, said power amplifier system including a loop by which a parameter proportional to output power of the power amplifier is sensed and fed to an error amplifier, and the output of the error amplifier is fed to a control input of the power amplifier as a control signal, the method comprising adding an extra gain to the loop.

2. The method according to claim 1, wherein said extra gain is proportional to said control signal.

3. The method according to claim 2, wherein said parameter proportional to output power comprises current.

4. The method according to claim 1 wherein said extra gain maintains said loop in an active state at all times.

5. The method according to claim 1, wherein said power amplifier system is utilized in a mobile terminal of a wireless communications system.

6. The method according to claim 5, wherein said mobile terminal is a cellular telephone.

7. The method according to claim 5, wherein said wireless communications system operates in accordance with GSM specifications.

8. A power amplifier system comprising:
a power amplifier for amplifying a signal;
a control circuit for controlling said power amplifier, said control circuit including a loop for sensing a parameter proportional to output power of said power amplifier and feeding it back to an error amplifier, the output of which is fed to a control input of said power amplifier as a control signal; and
said control circuit further including circuitry for adding extra gain to said loop.

9. The power amplifier system according to claim 8, wherein said extra gain is proportional to said control signal.

10. The power amplifier system according to claim 9, wherein said parameter comprises current.

11. The power amplifier system according to claim 10, wherein said system is incorporated in a mobile terminal of a wireless communications system.
